(19) United States
(12) Patent Application Publication
(10) Pub. No.: US 2002/0147677 A1
(43) Pub. Date: Oct. 10, 2002

(54) Method and system for property rental tenant approval, line of credit based rental payment, and deposit and rental payment insurance

(76) Inventor: Shaun Brady, Davidsonville, MD (US)

Correspondence Address: Supervisor, Patent Prosecution Services, PIPER MARBURY RUDNICK & WOLFE LLP, 1200 Nineteenth Street, N.W., Washington, DC, 20036-2412, US

(21) Appl. No.: 10/103,818

(22) Filed: Mar. 25, 2002

Related U.S. Application Data
(60) Provisional application No. 60/278,446, filed on Mar. 26, 2001.

(51) Int. Cl. G06F 17/60

(52) U.S. Cl. 705/38

(57) ABSTRACT

A system and method for providing assurances for real property rental, and in particular a system and method for property rental tenant approval, line of credit based rental payment, and deposit and rental payment insurance. A credit check is provided for a renter at the time of rental application. Upon approval, the renter is provided with a line of credit, via a financial institution. The line of credit is assigned to the landlord via an addendum to the lease between the landlord and the renter. The financial institution periodically pays the landlord for the rental, debits the line of credit, and issues a statement to the renter for the amount due. The renter then refreshes the line of credit for future payment.

This application claims priority from U.S. Provisional Application Serial No. 60/278,446 filed Mar. 26, 2001. The entirety of that provisional application is incorporated herein by reference.

### BACKGROUND OF THE INVENTION

Field of the Invention

The present invention relates to methods and systems for providing assurances for real property rental, and in particular to methods and systems for property rental tenant approval, line of credit based rental payment, and deposit and rental payment insurance

Related Art

Weatherly et al. U.S. Pat. No. 6,049,784 provides a method for creating and managing a lease agreement. The method includes providing predetermined financial information regarding a potential tenant and a potential landlord to a lease control intermediary, evaluating the information to determine the acceptability of the financial risk associated with the potential tenant, and creating a service product in the form of a guaranty directed to periodic lease payments from the lease control intermediary to the landlord for a predetermined amount defining a guaranty limit. The guaranty limit corresponds to a predetermined time period, with the guaranty obligation becoming active upon failure of the potential lessee to pay periodic lease payments by the end of the time period. A lease agreement is provided for execution by the landlord, tenant, and the lease control intermediary, and periodic lease payments received either from the tenant or made by the lease control intermediary are deposited according to the service product into an account held by the landlord, the payments having a management fee removed therefrom by the lease control intermediary.

Background of the Technology

It is known in the art to offer deposit insurance. It is not known to provide rental insurance via a line of credit, nor is it known to provide a full range of services that includes rental insurance in combination with deposit insurance and a line of credit

### SUMMARY OF THE INVENTION

An embodiment of the present invention, referred to as “AptPay™” offers one-stop outsourcing of resident screening and rent processing, collection, and deposit assurance services (referred to as “deposit insurance”) for the apartment industry. The invention includes a revolutionary new service that ensures service providers (such as landlords) receive full and timely rental payments from all covered residents every month, including a predefined amount of additional coverage should a covered resident default on their rental obligations. In one embodiment, a property's rental payments are factored at a very favorable discount rate because of the use of a unique risk control and collection process. AptPay™ uses agreements with technology and financial entities to provide the ability to offer a totally scalable solution, as well as the ability to create a number of derivative products and services given its direct access to hundreds of residents for each apartment community using the services of the present invention. A by-product of this service is the electronic collection of resident demographic and property performance data that will help improve the quality and availability of affordable housing.

The present invention includes several features and advantages, among which embodiments include the following.

An online credit screening service, referred to in one embodiment as AptApproval™, is used for all new and renewing apartment residents. In an embodiment of the present invention, rental applications are submitted in any format: via, for example, telephone or facsimile into a call center or input directly into a website via a server on a network, such as the Internet. A credit bureau report is analyzed, and the customer rental application is approved in 90 seconds based on the property owner's predefined approval criteria, and at the same time the customer is also approved to rent deposit free (referred to as “AptDeposit™”) and up to two months rental payment coverage (referred to as “AptAssurance™,” described further below). Application fees are consistent with fees paid for inferior services.

A resident or factoring based credit facility, referred to in one embodiment as AptAssurance™, is assigned to the landlord in an amount sufficient to assure a covered resident's rent will be paid for up to two months following default, and cover the landlord's normal eviction time period. In one embodiment, per an addendum to the rental agreement, the resident is obligated to send their monthly rent to a credit holder, and to pay any late fees or collection costs. Properties using this feature of the present invention enjoy a number of operating and marketing competitive advantages. Landlords are relieved of the headaches of resident screening, rent collection, and deposit management, and can focus more on marketing and resident retention concerns. Residents no longer have to come up with large upfront deposits before moving in, and can build a credit history like home owners, as well as obtain other incentives for paying their rent on time, including via an additional feature of the present invention referred to as AptRewards™, described further below. In addition, all covered rental payments, less fees for the service provider, are electronically or otherwise deposited into a property's account on the first working day of every month, which provides owners with improved cash flow and the potential for more favorable financing. Landlords are charged a flat monthly fee or rental payment discount rate that can be passed on directly to residents or marked-up in their base rental rates.

An embodiment referred to as AptRewards™ includes marketing alliances and programs for providing residents and owners with incentives (e.g., bonus miles or points) for timely rent payment and for using the services.

Additional advantages and novel features of the invention will be set forth in part in the description that follows, and in part will become more apparent to those skilled in the art upon examination of the following or upon learning by practice of the invention.

### DESCRIPTION OF THE FIGURES

FIG. 1 presents an overview of the components of a system in accordance with an embodiment of the present invention.

FIG. 2 is a flow chart of functionality in accordance with an embodiment of the present invention.

References will now be made in detail to embodiments of the present invention, examples of which are illustrated in the accompanying drawings.

### DESCRIPTION OF THE INVENTION

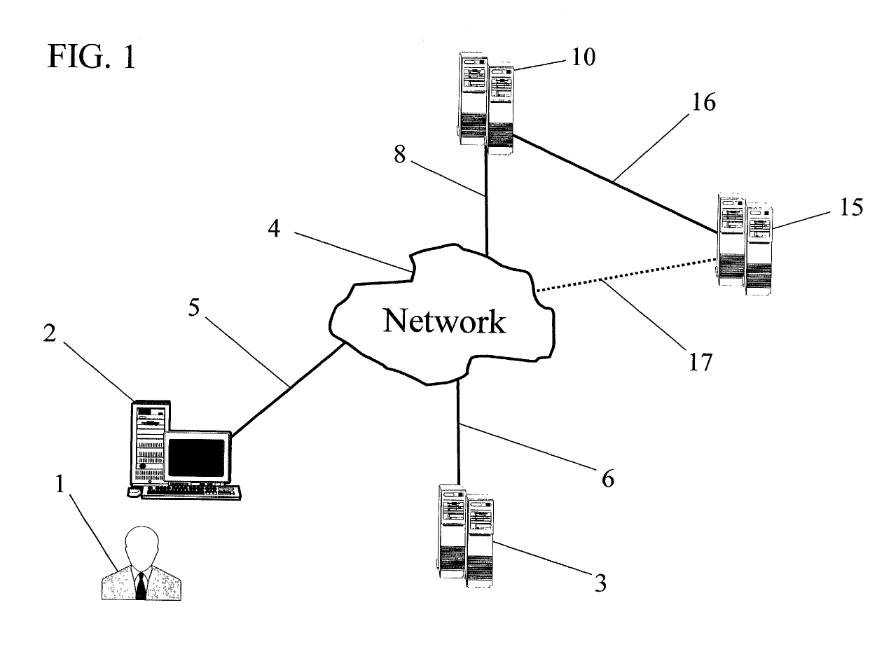

FIG. 1 presents an overview of the components of a system in accordance with an embodiment of the present invention. As shown in FIG. 1, a user 1, such as a real property rental service provider (e.g., landlord) provides input of information, such as renter identification and credit information, via a terminal 2. The terminal 2 comprises, for example, a personal computer (PC), a minicomputer, a microcomputer, a mainframe computer, a telephone, or a hand-held wireless electronic device. Information input to the terminal 2 is transmitted via couplings 5, 6 and network 4, such as the Internet, to a service provider server 3. The server 3 comprises, for example, a PC, a minicomputer, a microcomputer, a mainframe computer, a telephone, or other device having a processor and repository for data or coupling to a repository for data. The couplings 5, 6 include, for example, wired, wireless, or fiberoptic links. Information regarding the renter is then transmitted from a service provider server 3, via couplings 6, 8 to a financial institution server. In a preferred embodiment, the financial institution server includes a bank server and a credit bureau server 15. The host for the bank server 10, such as a bank or other credit provider, then approves or disapproves a credit line for the renter via a credit bureau. Approval or disapproval is determined, for example, following transmittal of renter information, including credit information, from the bank server 10 to the credit bureau server 15. This information may be transmitted via a secure coupling 16 or, optionally, via the network 4 and coupling 8 and optional coupling 17. Credit analysis information is then transmitted from the credit bureau server 15 to the bank server 10. The host for the bank server 10 then transmits approval or disapproval information from the bank server 10 via couplings 8, 5 and network 4 to the terminal 2. If approved, the credit line may be unsecured and include, for example, the value of the deposit for a rental property plus the value of an additional one month of rent.

In one embodiment of the present invention, the credit line is provided by the bank to the renter and then assigned by the renter to the landlord via an addendum agreement to the renter's lease with the landlord. On a periodic basis, such as monthly, the credit line is debited by the bank for payment of rent, which is made by the bank to the landlord. A statement of account is then transmitted from the bank to the renter, and the renter is obligated to pay the credit extended for the rental payment, along with, for example, interest, fees, and late charges, if any.

In an embodiment of the present invention, a fee is charged by the host for the service provider server 3, a second fee is charged by the credit bureau, and a periodic interest rate payment and/or other fee is charged by the bank for the credit line provided. Optionally, these fees are incorporated into the payment for the line of credit made by the renter or into the rental payment amount.

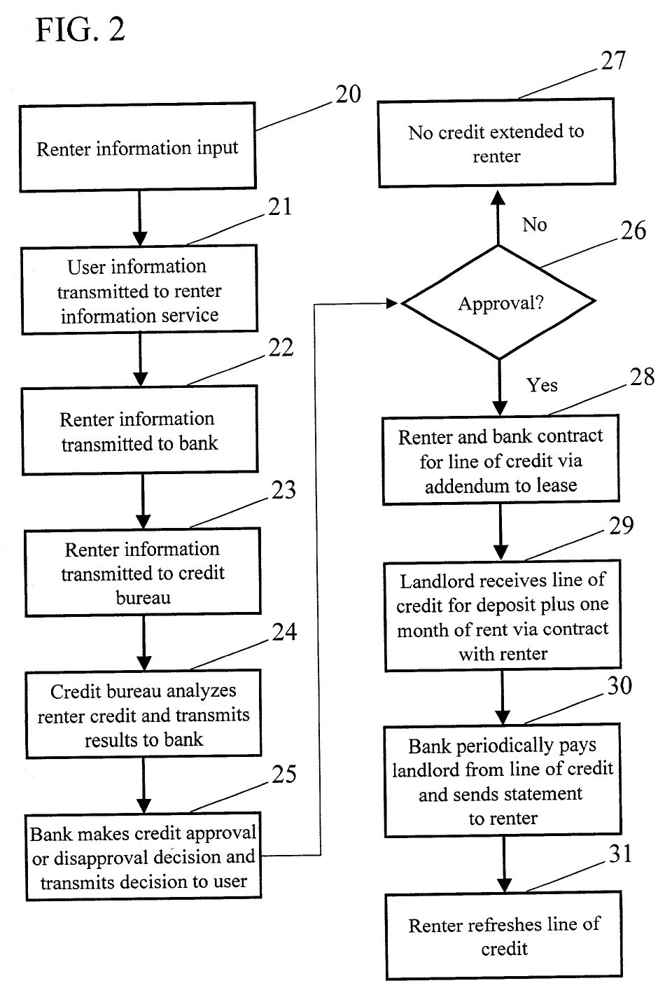

FIG. 2 is a flow chart of functionality in accordance with an embodiment of the present invention. As shown in FIG. 2, initially, renter information is input or otherwise provided 20, such as by input at a computer terminal or written recording. The user information is then transmitted to a renter information service 21, such as by transmitting the information over a network, such as the Internet, from the terminal to which the renter information is input to a server for the renter information service. Alternatively, the information may be transmitted, for example, by telephone voice communication or by mail.

The renter information is then transmitted from the renter information service to a bank or other credit provider 22. The information may be transmitted electronically, such as from the renter information service server to the bank server, or by other methods, such as by telephone or mail. The renter information is then similarly transmitted from the bank to a credit bureau 23 for credit analysis. The credit bureau analyzes the renter's credit and then provides the results to the bank 24. The bank makes a credit approval or disapproval decision and then transmits this determination to the user 25, such as the landlord to whom the renter has submitted information.

If the bank did not approve credit for the renter 26, no credit is extended to the renter 27. If the bank approves credit for the renter 26, the renter and the bank contract for a credit line and assign the credit line to the landlord via an addendum to the lease executed by the renter 28. The landlord then receives a line of credit in an amount equal to the deposit for the rental property plus one month of rent via contract with the renter 29. The bank periodically pays the landlord for the property, debits the line of credit for the amount of payment, and transmits a statement to the renter in the amount of the payment 30. The renter then pays the amount owed on the line of credit so as to refresh the line of credit for future payment 31.

As a result of this method, the following advantages, among others, are realized: the renter is not required to pay an upfront deposit and may qualify for a larger or more expensive apartment; the landlord eliminates its check collection and processing costs, receives a defined and more timely cashflow, and is assured of up to two months rent in event of renter default; and, the bank obtains a low cost consumer credit origination portal, and fees or interest on a new type of restricted and relatively safe unsecured revolving loan to the renter.

Example embodiments of the present invention have now been described in accordance with the above advantages. It will be appreciated that these examples are merely illustrative of the invention. Many variations and modifications will be apparent to those skilled in the art.

What is claimed is:

1. A computer-implemented system for providing a renter with a line of credit for rental payments comprising:
a terminal coupled to a network for receiving information regarding a renter; and
a server coupled to the network for receiving the information and for transmitting line of credit approval information;
wherein the information is provided to a financial institution;
wherein the information is evaluated to determine a level of risk associated with the renter;
wherein if the level of risk is approved, the renter is provided with a line of credit;
wherein the line of credit is assigned to a service provider; and
wherein the financial institution periodically pays the service provider and debits the line of credit.

2. The system of claim 1, wherein the renter refreshes the line of credit.

3. The system of claim 1, wherein the renter is a potential renter.

4. The system of claim 1, wherein the service provider is a potential service provider.

5. The system of claim 1, wherein the service provider is a landlord.

6. The system of claim 1, wherein the information comprises renter identification information and credit information.

7. The system of claim 1, wherein the information comprises resident demographic and property performance information that helps improve quality and availability of affordable housing.

8. The system of claim 1, wherein the terminal comprises a personal computer (PC), a minicomputer, a microcomputer, a mainframe computer, a telephone, or a hand-held wireless electronic device.

9. The system of claim 1, wherein the server comprises a personal computer (PC), a minicomputer, a microcomputer, a mainframe computer, a telephone, or other device having a processor and repository for data or coupling to a repository for data.

10. The system of claim 1, wherein the line of credit is unsecured.

11. The system of claim 1, wherein the line of credit provides a rental service provider rental payments from the renter every month, including a predefined amount of additional coverage should the renter default on rental obligations.

12. The system of claim 1, wherein the line of credit includes a value of a deposit for a rental property plus a value of an additional one month of rent.

13. The system of claim 1, wherein the rental payments are factored at a favorable discount rate due to the line of credit.

14. The system of claim 1, wherein the renter is approved to rent deposit free.

15. The system of claim 1, wherein the renter is approved for future rental payment coverage.

16. The system of claim 1, wherein a rental agreement provides that the renter is obligated to send their rent to the financial institution.

17. The system of claim 1, wherein a rental agreement provides that the renter is obligated to pay at least one of late fees or collection costs.

18. The system of claim 1, further comprising marketing programs for providing renters and service providers with incentives for using the system.

19. The system of claim 1, wherein the network comprises an Internet or an Intranet.

20. The system of claim 1, further comprising coupling for transmitting the information from the network to the server.

21. The system of claim 20, wherein the coupling comprises wired links, wireless links, or fiberoptic links.

22. The system of claim 1, further comprising:
a service provider server for transmitting information to a financial institution server; and
the financial institution server for transmitting information to the service provider server.

23. The system of claim 22, further comprising:
a service provider terminal; and
a financial institution terminal.

24. The system of claim 21, further comprising:
a credit bureau server for transmitting the information to the financial institution server.

25. The system of claim 24, further comprising:
a credit bureau terminal.

26. A method for providing a line of credit for rental payments comprising:
providing information regarding a renter to a financial institution;
evaluating the information to determine a level of risk associated with the renter;
if the level of risk is approved, providing the renter with a line of credit;
assigning the line of credit to a service provider; and
the financial institution periodically paying the service provider and debiting the line of credit.

27. The method of claim 26, wherein a line of credit is provided electronically.

28. The method of claim 26, wherein the service provider is a landlord.

29. The method of claim 26, wherein the information regarding the renter comprises renter identification and credit information.

30. The method of claim 26, wherein the information regarding the renter comprises resident demographic and property performance information that helps improve the quality and availability of affordable housing.

31. The method of claim 26, wherein the renter is a potential renter.

32. The method of claim 26, wherein the service provider is a potential service provider.

33. The method of claim 26, wherein debiting the line of credit comprises issuing a statement to the renter for the amount due.

34. The method of claim 26, wherein the line of credit is unsecured.

35. The method of claim 26, wherein evaluating comprises:
transmitting the information from a credit bureau to a financial institution; and
transmitting approval or disapproval information from the financial institution to the service provider.

36. The method of claim 26, wherein the line of credit includes a value of a deposit for a rental property plus a value of an additional one month of rent.

37. The method of claim 26, wherein rental payments are factored at a favorable discount rate due to the line of credit.

38. The method of claim 26, wherein the renter is approved to rent deposit free.

39. The method of claim 26, wherein the renter is approved for future rental payment coverage.

40. The method of claim 26, further comprising:
the renter refreshing the line of credit.

41. The method of claim 26, wherein the renter and the service provider are parties to a rental agreement providing that the renter is obligated to send rent to the financial institution.

42. The method of claim 41, wherein the rental agreement provides for the renter refreshing the line of credit.
